(19) United States
(12) Patent Application Publication
(10) Pub. No.: US 2022/0335483 A1
(43) Pub. Date: Oct. 20, 2022

(54) SHOP SYSTEM, AND SHOP SERVER

(71) Applicant: NEC Corporation, Minato-ku, Tokyo (JP)

(72) Inventor: Masamichi TANABE, Tokyo (JP)

(73) Assignee: NEC Corporation, Minato-ku, Tokyo (JP)

(21) Appl. No.: 17/762,801

(22) PCT Filed: Sep. 30, 2020
(86) PCT No.: PCT/JP2020/037124

§ 371 Date: Mar. 23, 2022

(30) Foreign Application Priority Data
Sep. 30, 2019 (JP) 2019-178290

(51) Int. Cl. G06Q 30/02; G06Q 30/06; G07C 9/25

(52) U.S. Cl. CPC G06Q 30/0281; G06Q 30/06; G07C 9/25

(57) ABSTRACT

In a delivery network system, deliver a server that holds requested content is determined, using information included in a content request message from a communication terminal. A file or stream of the requested content is read from the determined server. When the content is moving image content, a bandwidth of a mobile network is estimated, based on a response signal or a congestion state notification signal from the communication terminal. The moving content is transmitted by controlling a timing of transmitting the read file or the read stream so as not exceed the estimated bandwidth.

### TECHNICAL FIELD

The present invention relates to a shop system, a shop server, and a processing method for a shop system.

### BACKGROUND ART

A technique related to the present invention is disclosed in Patent Documents 1 and 2. Patent Document 1 discloses a vending machine system for performing an age confirmation of a customer, and selling a product when a condition is satisfied. Patent Document 2 discloses a system for performing authentication based on a face image, and unlocking a product shelf when the authentication is successful.

### RELATED DOCUMENT

### Patent Document

[Patent Document 1] Japanese Patent Application Publication No. 2013-206232
[Patent Document 2] Japanese Patent Application Publication No. 2009-9231

### DISCLOSURE OF THE INVENTION

### Technical Problem

In recent years, in an unattended/labor-saving shop being widely discussed, contrivance is needed for a method of selling an age limited product such as alcohol and a cigarette.

The present invention has a challenge to suppress an inconvenience of selling an age limited product to a customer who does not satisfy a purchase condition in an unattended/labor-saving shop.

### Solution to Problem

The present invention provides a shop system including:

a taken-out time acquisition means for acquiring customer determination information input to a lock control apparatus that controls a lock of a locked shelf in which an age limited product is displayed;

a taken-out time decision means for deciding whether a customer determined by the customer determination information has already executed age confirmation processing and whether the customer satisfies a purchase condition of the age limited product; and

a lock control means for transmitting, to the lock control apparatus, a release instruction for releasing a lock of the locked shelf when the customer has already executed the age confirmation processing and satisfies the purchase condition.

Further, the present invention provides a shop system including:

an accounting time acquisition means for acquiring customer determination information input to an accounting apparatus;

an accounting time decision means for deciding, when an age limited product is registered as an accounting target in the accounting apparatus, whether a customer determined by the customer determination information has already executed age confirmation processing and whether the customer satisfies a purchase condition of the age limited product; and

an accounting control means for transmitting a sales permission to the accounting apparatus when the customer has already executed the age confirmation processing and satisfies the purchase condition.

Further, the present invention provides a processing method of a shop system including:

by a shop system,
acquiring customer determination information input to a lock control apparatus that controls a lock of a locked shelf in which an age limited product is displayed;
deciding whether a customer determined by the customer determination information has already executed age confirmation processing and whether the customer satisfies a purchase condition of the age limited product; and
transmitting, to the lock control apparatus, a release instruction for releasing a lock of the locked shelf when the customer has already executed the age confirmation processing and satisfies the purchase condition.

Further, the present invention provides a processing method of a shop system including:

by a shop system,
acquiring customer determination information input to an accounting apparatus;
deciding, when an age limited product is registered as an accounting target in the accounting apparatus, whether a customer determined by the customer determination information has already executed age confirmation processing and whether the customer satisfies a purchase condition of the age limited product; and
transmitting a sales permission to the accounting apparatus when the customer has already executed the age confirmation processing and satisfies the purchase condition.

Further, the present invention provides a shop server including:

a registration means for registering, in a customer list, customer determination information acquired from a customer;

a purchase condition decision means for deciding whether the customer satisfies a purchase condition of an age limited product, based on age confirmation information acquired from the customer when the customer enters a shop or the customer takes out the age limited product from a locked shelf, and registering, in the customer list, a decision result in association with the customer determination information;

an accounting time acquisition means for acquiring the customer determination information input to an accounting apparatus;

an accounting time decision means for referring to the customer list when the age limited product is registered as an accounting target in the accounting apparatus, and deciding whether a fact that the purchase condition is satisfied is registered in association with the customer determination information input to the accounting apparatus; and

an accounting control means for transmitting, to the accounting apparatus, a decision instruction for executing processing for deciding whether the customer satisfies the purchase condition, when a fact that the purchase condition is satisfied is not registered in association with the customer determination information input to the accounting apparatus.

### Advantageous Effects of Invention

The present invention is capable of suppressing an inconvenience of selling an age limited product to a customer who does not satisfy a purchase condition in an unattended/labor-saving shop.

### BRIEF DESCRIPTION OF THE DRAWINGS

FIG. 1 is one example of a functional block diagram of a shop system according to the present example embodiment.

FIG. 2 is one example of a layout in a shop where the shop system according to the present example embodiment is installed.

FIG. 3 is one example of a functional block diagram of a shop server according to the present example embodiment.

FIG. 4 is a diagram schematically illustrating one example of information processed by the shop server according to the present example embodiment.

FIG. 5 is a diagram schematically illustrating one example of information processed by the shop server according to the present example embodiment.

FIG. 6 is a flowchart illustrating one example of a flow of processing of the shop server according to the present example embodiment.

FIG. 7 is a flowchart illustrating one example of a flow of processing of the shop server according to the present example embodiment.

FIG. 8 is a flowchart illustrating one example of a flow of processing of the shop server according to the present example embodiment.

FIG. 9 is a diagram illustrating one example of a hardware configuration of the shop server according to the present example embodiment.

### DESCRIPTION OF EMBODIMENTS

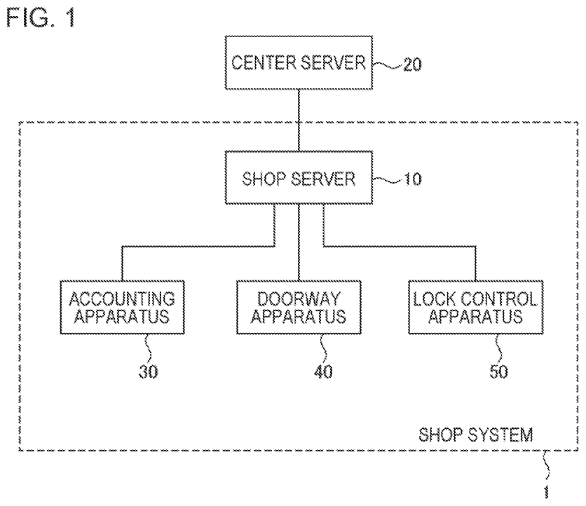

FIG. 1 is one example of a functional block diagram of a shop system 1 according to the present example embodiment. As illustrated, the shop system 1 includes a shop server 10, an accounting apparatus 30, a doorway apparatus 40, and a lock control apparatus 50. Each of the accounting apparatus 30, the doorway apparatus 40, and the lock control apparatus 50, and the shop server 10 are configured to be able to communicate with each other. Further, the shop server 10 is configured to be able to communicate with a center server 20.

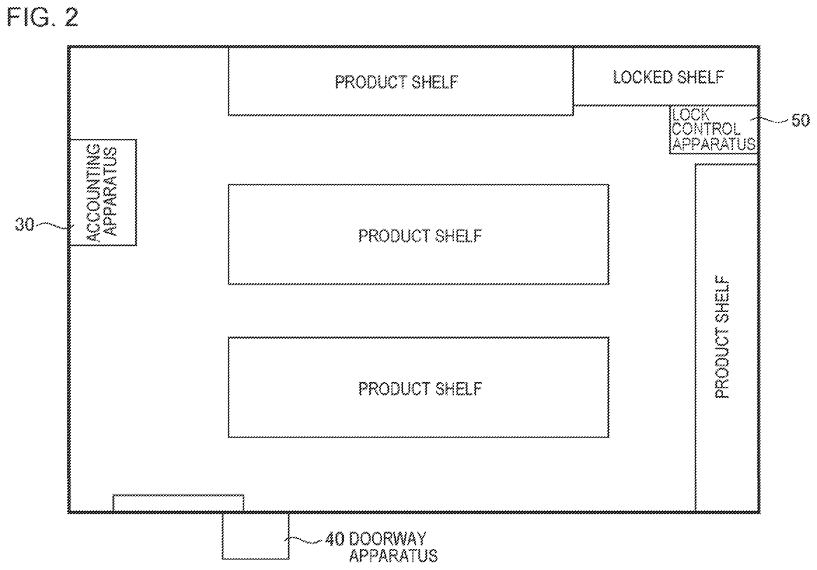

FIG. 2 schematically illustrates one example of a shop layout. The doorway apparatus 40 is installed in a doorway of a shop. The lock control apparatus 50 is installed near a locked shelf. In the locked shelf, an age limited product is displayed. The age limited product is a product that cannot be sold to a customer whose age does not satisfy a purchase condition, and, for example, alcohol and cigarettes are exemplified. The accounting apparatus 30 is installed in any position in the shop. Although not illustrated, the shop server 10 is installed in a stockroom or the like of the shop, for example.

Next, an outline of the shop system 1 according to the present example embodiment will be described based on a flow of a purchase of an age limited product by a customer who comes to a shop.

First, the customer who comes to the shop inputs, to the doorway apparatus 40, customer determination information that determines himself/herself. A door or a gate in a doorway may be configured to open in response to an input of customer determination information to the doorway apparatus 40. For example, the customer may perform membership registration in advance, and input, to the doorway apparatus 40, his/her membership identification information as customer determination information. In addition, the customer may input, to the doorway apparatus 40, his/her face image as customer determination information by causing a camera included in the doorway apparatus 40 to capture his/her face image. The doorway apparatus 40 transmits the input customer determination information to the shop server 10. The shop server 10 registers the acquired customer determination information in a customer list.

Note that, the customer may execute age confirmation processing at a time of advance membership registration. Then, the customer having already executed the age confirmation processing and a decision result of whether the customer satisfies a purchase condition of an age limited product may be registered as membership information in the center server 20.

When membership identification information is input as customer determination information to the doorway apparatus 40, the shop server 10 acquires membership information associated with the membership identification information from the center server 20, and registers the membership information in the customer list.

Further, the customer may operate the doorway apparatus 40, and execute the age confirmation processing when the customer enters the shop. In this case, the shop server 10 registers, in the customer list, the customer having already executed the age confirmation processing and a decision result of whether the customer satisfies a purchase condition.

After entering the shop, the customer who purchases an age limited product inputs his/her customer determination information to the lock control apparatus 50. The lock control apparatus 50 transmits the input customer determination information to the shop server 10. The shop server 10 refers to the customer list, and confirms whether the age confirmation processing having already been executed and a fact that the purchase condition is satisfied are registered in association with the input customer determination information. When the age confirmation processing having already been executed and the fact that the purchase condition is satisfied are registered, the shop server 10 transmits, to the lock control apparatus 50, a release instruction for releasing a lock. The lock control apparatus 50 releases a lock of a locked shelf in response to the release instruction.

On the other hand, when the age confirmation processing having already been executed is not registered, the shop server 10 transmits, to the lock control apparatus 50, a decision instruction for executing processing for deciding whether the customer satisfies the purchase condition. The lock control apparatus 50 receives, from the customer, the age confirmation processing in response to the decision instruction. Then, when the customer satisfies the purchase condition, the shop server 10 transmits, to the lock control apparatus 50, the release instruction for releasing a lock. Further, the shop server 10 registers, in the customer list, the customer having already executed the age confirmation processing and a decision result of whether the customer satisfies the purchase condition. The lock control apparatus 50 releases the lock of the locked shelf in response to the release instruction. On the other hand, when the customer does not satisfy the purchase condition, the shop server 10 causes the lock control apparatus 50 to execute error processing. In this case, the lock control apparatus 50 does not release the lock of the locked shelf.

Subsequently, the customer operates the accounting apparatus 30, and executes accounting processing. Then, when the age limited product is registered as an accounting target in the accounting apparatus 30, the shop server 10 refers to the customer list, and confirms whether the age confirmation processing having already been executed and that fact that the purchase condition is satisfied are registered in association with the customer determination information input to the accounting apparatus.

Then, when the age confirmation processing having already been executed and the fact that the purchase condition is satisfied are registered, the shop server 10 transmits a sales permission to the accounting apparatus 30. In this case, the accounting apparatus 30 keeps continuing the accounting processing.

On the other hand, when the age confirmation processing having already been executed is not registered, the shop server 10 transmits, to the accounting apparatus 30, a decision instruction for executing processing for deciding whether the customer satisfies the purchase condition. The accounting apparatus 30 receives, from the customer, the age confirmation processing in response to the decision instruction. Then, when the customer satisfies the purchase condition, the shop server 10 transmits the sales permission to the accounting apparatus 30. In this case, the accounting apparatus 30 keeps continuing the accounting processing. On the other hand, when the customer does not satisfy the purchase condition, the shop server 10 causes the accounting apparatus 30 to execute the error processing.

In this way, the shop server 10 according to the present example embodiment confirms whether a customer satisfies a purchase condition of an age limited product at both of a time at which the age limited product is taken out from a locked shelf and an accounting time. Thus, even at an occurrence of wrongdoing in such a way that a customer who does not satisfy a purchase condition takes out an age limited product from a locked shelf when another customer releases a lock of the locked shelf, the customer cannot normally execute the accounting processing. Thus, an inconvenience of selling an age limited product to a customer who does not satisfy a purchase condition can be suppressed.

Further, in a case of the shop server 10 according to the present example embodiment, when the age confirmation processing is executed at any of a time of advance membership registration, a time at which a customer enters a shop, and a time at which an age limited product is taken out from a locked shelf, the age confirmation processing being executed and a decision result are registered in the shop server 10. Then, after the registration, the shop server 10 confirms whether a customer satisfies a purchase condition of the age limited product, based on the registration information. Thus, as described above, the shop server 10 confirms whether a customer satisfies a purchase condition of an age limited product twice at a time at which the age limited product is taken out from a locked shelf and an accounting time, but the customer should execute the age confirmation processing only once, and the processing being executed for a plurality of times can be avoided. Thus, convenience improves.

Next, a functional configuration of the shop server 10 will be described in detail. Note that, in the description of the functional configuration of the shop server 10, a functional configuration of the center server 20, the accounting apparatus 30, the doorway apparatus 40, and the lock control apparatus 50 will be described as appropriate.

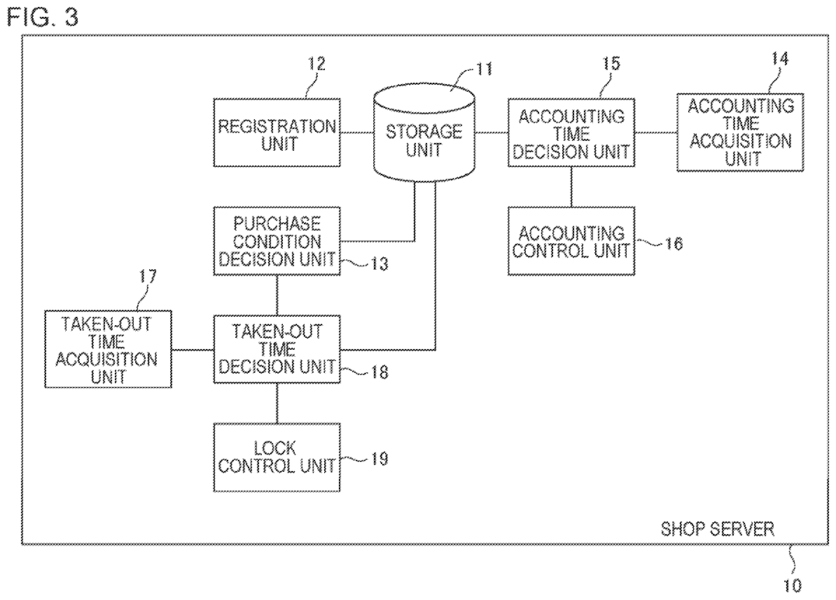

FIG. 3 is one example of a functional block diagram of the shop server 10. As illustrated, the shop server 10 includes a storage unit 11, a registration unit 12, a purchase condition decision unit 13, an accounting time acquisition unit 14, an accounting time decision unit 15, an accounting control unit 16, a taken-out time acquisition unit 17, a taken-out time decision unit 18, and a lock control unit 19. Note that, the shop server 10 may not include the storage unit 11. In this case, an external apparatus configured to be able to communicate with the shop server 10 includes the storage unit 11.

The registration unit 12 registers, in a customer list, customer determination information acquired from a customer. For example, the registration unit 12 acquires customer determination information input to the doorway apparatus 40 by a customer when the customer enters a shop. Then, when the customer determination information is not registered in the customer list, the registration unit 12 registers the customer determination information in the customer list. Further, the registration unit 12 acquires customer determination information input to the lock control apparatus 50 by a customer when the customer takes out an age limited product from a locked shelf. Then, when the customer determination information is not registered in the customer list, the registration unit 12 registers the customer determination information in the customer list.

The customer determination information is member identification information or a face image. For example, the doorway apparatus 40 and the lock control apparatus 50 may read, via a reader, membership identification information by a means, such as short-range wireless communication, from a storage apparatus (such as an IC card, a smartphone, a smartwatch, and a cellular phone) that stores the membership identification information. Further, the doorway apparatus 40 and the lock control apparatus 50 may receive an input of membership identification information via an input apparatus such as a touch panel and a physical button. Further, the doorway apparatus 40 and the lock control apparatus 50 may capture a face image of a customer with a camera.

A customer list may be a list of customers present in a shop, a list of customers who come to a shop, a list of customers who come to a shop within a predetermined period, or another list.

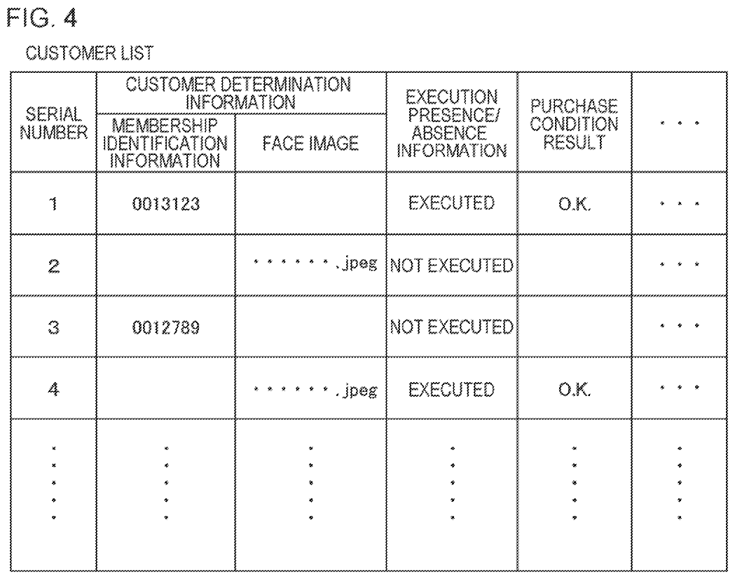

The storage unit 11 stores the customer list. FIG. 4 schematically illustrates one example of the customer list. In the illustrated customer list, a serial number, customer determination information, execution presence/absence information indicating whether the age confirmation processing has already been executed, and a purchase condition result indicating whether a purchase condition is satisfied are associated with one another. Note that, the customer list may further include other information.

Returning to FIG. 3, the purchase condition decision unit 13 decides whether a customer satisfies a purchase condition of an age limited product, based on age confirmation information acquired from the customer when the customer enters a shop or takes out the age limited product, and registers, in the customer list, the age confirmation processing having already been executed and a decision result in association with the customer determination information.

For example, the purchase condition decision unit 13 acquires the age confirmation information from the doorway apparatus 40 or the lock control apparatus 50. For example, the doorway apparatus 40 and the lock control apparatus 50 may capture an object (for example: a driver's license, a health insurance card, my number card, or the like) including information that can confirm status and age, and acquire an image of the object as the age confirmation information. In this case, the purchase condition decision unit 13 may recognize the age confirmation information included in the image by using an image analysis technique and a character recognition technique, and decide whether age of a customer determined by the age confirmation information satisfies a purchase condition (for example, 20 years old or older). Further, when a face image is included in the acquired image, the purchase condition decision unit 13 may decide whether the face image included in the acquired image and a face image acquired by the registration unit 12 as the customer determination information are a face image of the same person. Then, deciding that it is the same person may be one of conditions for deciding whether a purchase condition is satisfied.

As another example, when information that can confirm status and age is stored in a storage apparatus (such as an IC card, a smartphone, a smartwatch, and a cellular phone), the doorway apparatus 40 and the lock control apparatus 50 may read, from the storage apparatus, the information that can confirm status and age by a means such as short-range wireless communication. Then, when biometric information (for example: a fingerprint, a voiceprint, an iris, or the like) is stored in the storage apparatus, the doorway apparatus 40 and the lock control apparatus 50 may further read the biometric information from the storage apparatus. Further, the doorway apparatus 40 and the lock control apparatus 50 may further receive an input of biometric information from a customer who comes to a shop. Then, the purchase condition decision unit 13 may decide whether the biometric information read from the storage apparatus and the biometric information input by the customer who comes to the shop are the same person's (whether the pieces of biometric information coincide with each other). Then, deciding that it is the same person may be one of conditions for deciding whether a purchase condition is satisfied.

As another example, the doorway apparatus 40 and the lock control apparatus 50 may output a question of, for example, “are you 20 years old or older?” via an output apparatus such as a display, and also receive an input of an answer (“yes” or “no”) to the question. Then, the purchase condition decision unit 13 may acquire the answer as age confirmation information. In this case, the purchase condition decision unit 13 decides that age of a customer satisfies a purchase condition when the answer is “yes”, and decides that the age of the customer does not satisfy the purchase condition when the answer is “no”.

Further, when the registration unit 12 acquires membership identification information as customer determination information, and execution presence/absence information indicating whether the age confirmation processing has already been executed and a purchase condition result indicating whether a purchase condition of an age limited product is satisfied are registered in a membership database generated in advance, the purchase condition decision unit 13 may register the pieces of information in association with the customer determination information in the customer list. The membership database is a database generated by advance membership registration described above, and is stored in the center server 20.

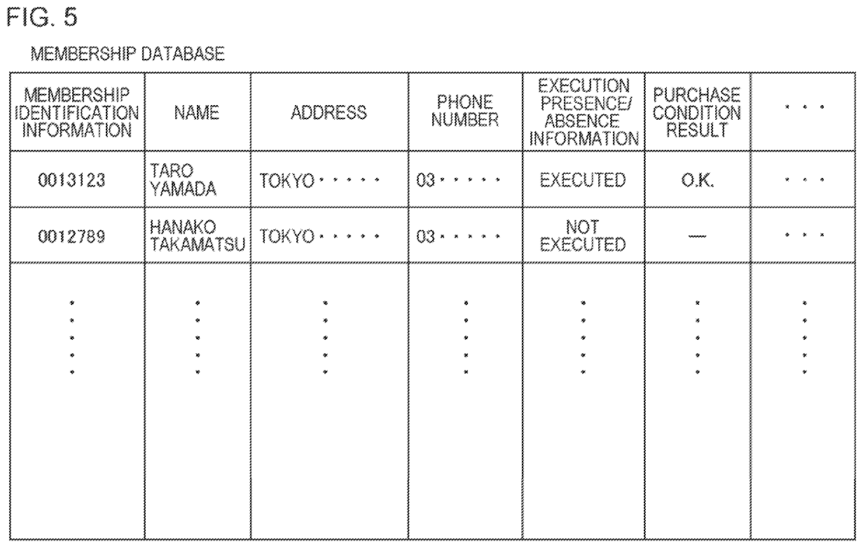

FIG. 5 schematically illustrates one example of the membership database. In the illustrated example, membership identification information, a name, an address, a phone number, execution presence/absence information indicating whether the age confirmation processing has already been executed, and a purchase condition result indicating whether a purchase condition is satisfied are associated with one another. Note that, the membership database may further include other information. Advance membership registration is achieved via an application and a Web page, for example.

As described above, a customer can execute the age confirmation processing at a time of advance membership registration. As described above, the age confirmation processing is provision of information that can confirm status and age, an answer (“yes” or “no”) to a question of “are you 20 years old or older?”, and the like, which are not limited thereto. When the age confirmation processing is executed at a time of advance membership registration, the center server 20 executes processing similar to that of the purchase condition decision unit 13 described above, and decides whether age of the customer satisfies a purchase condition. Then, the center server 20 registers, in the membership database, the age confirmation processing having already been executed and a decision result in association with membership identification information about the customer.

Returning to FIG. 3, the taken-out time acquisition unit 17 acquires customer determination information input to the lock control apparatus 50 that controls a lock of a locked shelf in which an age limited product is displayed.

The taken-out time decision unit 18 decides whether a customer determined by the customer determination information has already executed the age confirmation processing and whether the customer satisfies a purchase condition of an age limited product. Specifically, the taken-out time decision unit 18 refers to the customer list stored in the storage unit 11, and decides whether the age confirmation processing having already been executed and a fact that the purchase condition of the age limited product is satisfied are registered in association with the customer determination information input to the lock control apparatus 50.

When the age confirmation processing having already been executed and that fact that the purchase condition of the age limited product is satisfied are registered, in the customer list stored in the storage unit 11, in association with the customer determination information input to the lock control apparatus 50, the lock control unit 19 transmits, to the lock control apparatus 50, a release instruction for releasing the lock of the locked shelf. The lock control apparatus 50 releases the lock of the locked shelf in response to the release instruction. Note that, a configuration of a lock of a locked shelf, a mechanism for a lock release based on a release instruction (electric signal), and the like are design matters, and details thereof are not particularly limited.

Note that, when the age confirmation processing having already been executed is not registered, in the customer list stored in the storage unit 11, in association with the customer determination information input to the lock control apparatus 50, or when the customer determination information input to the lock control apparatus 50 is not registered in the customer list, the purchase condition decision unit 13 transmits, to the lock control apparatus 50, a decision instruction for executing processing for deciding whether the customer satisfies a purchase condition.

In the present example embodiment, a customer is required to input customer determination information to the doorway apparatus 40 when the customer enters a shop. However, it is expected that a customer who enters a shop without following this appears. Further, even with a configuration in which a door or a gate in a doorway opens in response to an input of customer determination information to the doorway apparatus 40, it is expected that a customer who enters a shop when another customer opens the door or the gate in the doorway appears. Thus, a situation where customer determination information input to the lock control apparatus 50 is not registered in a customer list may occur.

The lock control apparatus 50 receives, from the customer, the age confirmation processing in response to the decision instruction transmitted from the shop server 10. As described above, the age confirmation processing is provision of information that can confirm status and age, an answer (“yes” or “no”) to a question of “are you 20 years old or older?”, and the like, which are not limited thereto.

The purchase condition decision unit 13 acquires the age confirmation information from the lock control apparatus 50, and decides whether the customer satisfies a purchase condition, based on the acquired age confirmation information. Then, the purchase condition decision unit 13 registers, in the customer list, the age confirmation processing having already been executed and a decision result in association with the customer determination information. Details of the decision are as described above. When the decision result indicates that the customer satisfies the purchase condition, the lock control unit 19 transmits the release instruction to the lock control apparatus 50.

Further, when the decision result indicates that the customer does not satisfy the purchase condition, or when the purchase condition not being satisfied is registered, in the customer list, in association with the customer determination information input to the lock control apparatus 50, the lock control unit 19 causes the lock control apparatus 50 to execute the error processing without transmitting the release instruction to the lock control apparatus 50. The lock control apparatus 50 may output, as the error processing, a sentence such as, for example, “a lock of a locked shelf cannot be released because it cannot be confirmed that your age satisfies a purchase condition.” via an output apparatus such as a display and a speaker.

Returning to FIG. 3, the accounting time acquisition unit 14 acquires the customer determination information input to the accounting apparatus 30. The accounting apparatus 30 may output a guide that prompts all customers to input customer determination information, and receive an input of the customer determination information from all the customers. In addition, the accounting apparatus 30 may output a guide that prompts only a customer who registers an age limited product as an accounting target to input customer determination information, and receive an input of the customer determination information from only the customer who registers the age limited product as the accounting target. Similarly to the doorway apparatus 40 and the like, the accounting apparatus 30 acquires, via a reader and a camera, membership identification information and a face image of a customer as customer determination information.

Note that, the accounting apparatus 30 is an apparatus assumed to be operated by a customer, and executes registration processing and settlement processing.

In the registration processing, the accounting apparatus 30 receives an input of identification information about a product being an accounting target via an input apparatus such as a code reader that reads a code indicating identification information about a product, a touch panel display, a physical button, and a microphone, an input system including a camera that captures an appearance of a product and an image analysis apparatus, and the like, for example. Then, the accounting apparatus 30 acquires, from a product master stored in advance in a storage apparatus included in the shop system 1, product information (such as a unit price) associated with the input identification information about the product, and registers the product information as an accounting target in a storage apparatus of the accounting apparatus 30.

In the settlement processing, the accounting apparatus 30 computes an accounting amount, based on product information registered as an accounting target, and receives a payment of the accounting amount. The accounting apparatus 30 can receive a payment using cash, a credit card, a point, and the like.

When an age limited product is registered as an accounting target in the accounting apparatus 30, the accounting time decision unit 15 decides whether a customer determined by customer determination information has already executed the age confirmation processing and whether the customer satisfies a purchase condition of the age limited product. Specifically, the accounting time decision unit 15 refers to a customer list stored in the storage unit 11, and decides whether the age confirmation processing having already been executed and the fact that the purchase condition of the age limited product is satisfied are registered in association with the customer determination information input to the accounting apparatus 30. For example, when an age limited product is registered as an accounting target, the accounting apparatus 30 may notify the shop server 10 of the registration. Further, during the notification, the accounting apparatus 30 may transmit input customer determination information to the shop server 10.

When the age confirmation processing having already been executed is not registered in association with the customer determination information input to the accounting apparatus 30, or when the customer determination information input to the accounting apparatus 30 is not registered in the customer list, the accounting control unit 16 transmits, to the accounting apparatus 30, a decision instruction for executing processing for deciding whether the customer satisfies a purchase condition.

In the present example embodiment, a customer is required to input customer determination information to the doorway apparatus 40 when the customer enters a shop. However, it is expected that a customer who enters a shop without following this appears. Further, even with a configuration in which a door or a gate in a doorway opens in response to an input of customer determination information to the doorway apparatus 40, it is expected that a customer who enters a shop when another customer opens the door or the gate in the doorway appears. Further, in the present example embodiment, when an age limited product is taken out from a locked shelf, an input of customer determination information to the lock control apparatus 50 is needed. However, it is expected that a customer who takes out an age limited product from a locked shelf when another customer releases a lock of the locked shelf appears. Thus, a situation where customer determination information input to the accounting apparatus 30 is not registered in a customer list may occur.

The accounting apparatus 30 receives, from the customer, the age confirmation processing in response to the decision instruction received from the shop server 10. As described above, the age confirmation processing is provision of information that can confirm status and age, an answer (“yes” or “no”) to a question of “are you 20 years old or older?”, and the like, which are not limited thereto.

The accounting control unit 16 acquires the age confirmation information from the accounting apparatus 30, and decides whether the customer satisfies a purchase condition, based on the acquired age confirmation information. Details of the decision are similar to those in the processing of the purchase condition decision unit 13.

Then, when the accounting control unit 16 decides that the customer satisfies the purchase condition, the accounting control unit 16 transmits the sales permission to the accounting apparatus 30. In this case, the accounting apparatus 30 proceeds with execution of the registration processing and the payment processing described above.

On the other hand, when the accounting control unit 16 decides that the customer does not satisfy the purchase condition, or when the purchase condition not being satisfied is registered, in the customer list, in association with the customer determination information input to the accounting apparatus 30, the accounting control unit 16 causes the accounting apparatus 30 to execute the error processing without transmitting the sales permission to the accounting apparatus 30. The accounting apparatus 30 may output, as the error processing, a sentence such as, for example, “OO (name of an age limited product) cannot be sold because it cannot be confirmed that your age satisfies a purchase condition.” via an output apparatus such as a display and a speaker.

Next, one example of a flow of processing of the shop server 10 will be described in detail by using a flowchart.

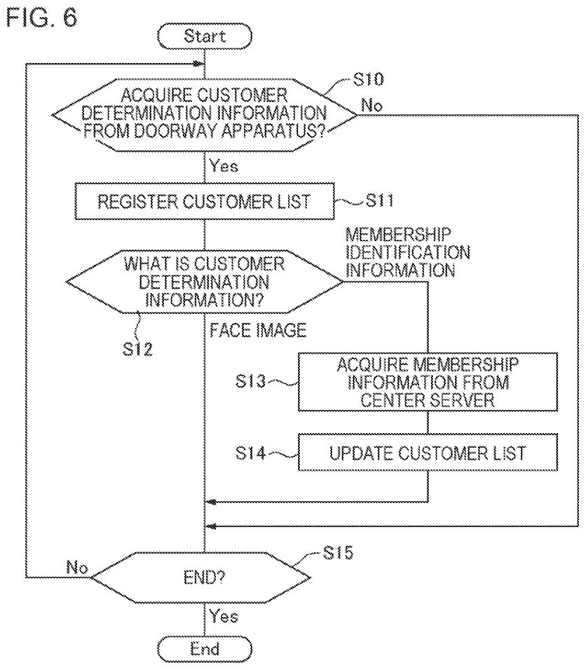

First, one example of a flow of processing executed by the shop server 10 when a customer enters a shop will be described by using a flowchart in FIG. 6.

First, a customer who comes to a shop inputs, to the doorway apparatus 40, customer determination information that determines himself/herself. The customer determination information is member identification information or a face image. For example, the customer brings a storage apparatus (such as an IC card, a smartphone, a smartwatch, and a cellular phone) that stores his/her membership identification information into a communicable state with a reader of the doorway apparatus 40 (for example: brings the storage apparatus closer to the reader). In response to this, the doorway apparatus 40 reads the membership identification information from the storage apparatus via the reader. Alternatively, the customer follows a guide output from the doorway apparatus 40, and causes the doorway apparatus 40 to capture his/her face image (customer determination information). The doorway apparatus 40 transmits the acquired customer determination information to the shop server 10.

When the registration unit 12 acquires the customer determination information from the doorway apparatus 40 (Yes in S10), the registration unit 12 registers the acquired customer determination information in a customer list (see FIG. 4) (S11). Note that, the registration unit 12 may confirm whether the acquired customer determination information is registered in the customer list, and, when the customer determination information is not registered, the registration unit 12 may register the customer determination information in the customer list.

Subsequently, when the registered customer determination information is membership identification information (“membership identification information” in S12), the purchase condition decision unit 13 requests membership information (see FIG. 5) associated with the membership identification information from the center server 20, and acquires the membership information (S13). Then, the purchase condition decision unit 13 executes processing of updating the customer list, based on the acquired membership information (S14). For example, when the age confirmation processing having already been executed and a decision result of whether a purchase condition is satisfied are included in the acquired membership information, the purchase condition decision unit 13 registers the information in the customer list.

On the other hand, when the registered customer determination information is a face image (“face image” in S12), the processing in S13 and S14 is not executed.

Note that, although not illustrated, the doorway apparatus 40 may receive the age confirmation processing from a customer. For example, the doorway apparatus 40 may output a question of “if you are planning to purchase an age limited product, you can confirm your age here. Do you want to confirm your age?”, and may also receive an input of an answer to the question. Then, when the answer is “yes”, the doorway apparatus 40 may receive the age confirmation processing from a customer. Then, the purchase condition decision unit 13 may acquire age confirmation information from the doorway apparatus 40, decide whether a purchase condition is satisfied, and update a customer list. Details of the processing are as described above.

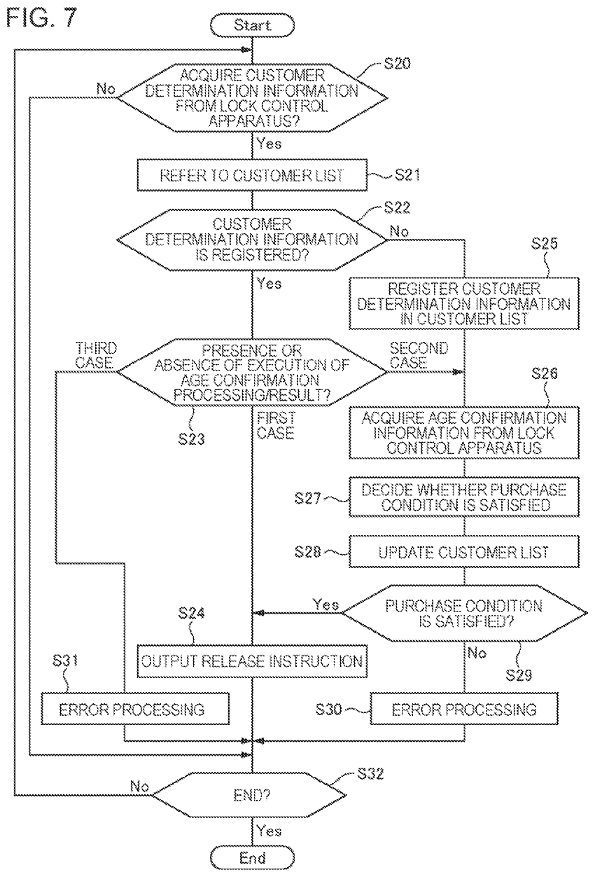

Next, one example of a flow of processing executed by the shop server 10 when a customer takes out an age limited product from a locked shelf will be described by using a flowchart in FIG. 7.

After entering a shop, a customer who purchases an age limited product inputs his/her customer determination information to the lock control apparatus 50. The customer determination information is member identification information or a face image. For example, the customer brings a storage apparatus (such as an IC card, a smartphone, a smartwatch, and a cellular phone) that stores his/her membership identification information into a communicable state with a reader of the lock control apparatus 50. In response to this, the lock control apparatus 50 reads the membership identification information from the storage apparatus via the reader. Alternatively, the customer follows a guide output from the lock control apparatus 50, and causes the lock control apparatus 50 to capture his/her face image (customer determination information). The lock control apparatus 50 transmits the acquired customer determination information to the shop server 10.

When the taken-out time decision unit 18 acquires the customer determination information from the lock control apparatus 50 (Yes in S20), the taken-out time decision unit 18 refers to a customer list stored in the storage unit 11 (S21), and confirms whether the acquired customer determination information is registered in the customer list (S22). When the customer determination information is registered (Yes in S22), the taken-out time decision unit 18 confirms whether the age confirmation processing having already been executed and a fact that a purchase condition of the age limited product is satisfied are registered in association with the customer determination information (S23).

When the age confirmation processing having already been executed and the fact that the purchase condition of the age limited product is satisfied are registered (first case in S23), the lock control unit 19 transmits, to the lock control apparatus 50, a release instruction for releasing a lock of a locked shelf (S24). The lock control apparatus 50 releases the lock of the locked shelf in response to the release instruction.

On the other hand, when the age confirmation processing having already been executed is not registered (second case in S23), the purchase condition decision unit 13 transmits, to the lock control apparatus 50, a decision instruction for executing processing for deciding whether the customer satisfies the purchase condition. The lock control apparatus 50 receives, from the customer, the age confirmation processing in response to the decision instruction, and transmits input age confirmation information to the shop server 10.

When the purchase condition decision unit 13 acquires the age confirmation information from the lock control apparatus 50 (S26), the purchase condition decision unit 13 decides whether the customer satisfies the purchase condition, based on the age confirmation information (S27), and updates the customer list (S28). Specifically, the purchase condition decision unit 13 registers the age confirmation processing having already been executed and a decision result in association with the customer determination information about the customer.

Next, when the customer satisfies the purchase condition (Yes in S29), the lock control unit 19 transmits, to the lock control apparatus 50, the release instruction for releasing the lock of the locked shelf (S24). The lock control apparatus 50 releases the lock of the locked shelf in response to the release instruction.

On the other hand, when the customer does not satisfy the purchase condition (No in S29), the lock control unit 19 causes the lock control apparatus 50 to execute error processing (S30). The lock control apparatus 50 may output, as the error processing, a sentence such as, for example, “a lock of a locked shelf cannot be released because it cannot be confirmed that your age satisfies a purchase condition.” via an output apparatus such as a display and a speaker. Note that, in this case, the lock control unit 19 does not transmit, to the lock control apparatus 50, the release instruction for releasing the lock of the locked shelf. Then, the lock control apparatus 50 does not release the lock of the locked shelf.

Further, when the age confirmation processing having already been executed and the purchase condition of the age limited product not being satisfied are registered (third case in S23), the lock control unit 19 causes the lock control apparatus 50 to execute the error processing (S31). The lock control apparatus 50 may output, as the error processing, a sentence such as, for example, “a lock of a locked shelf cannot be released because it cannot be confirmed that your age satisfies a purchase condition.” via an output apparatus such as a display and a speaker. Note that, in this case, the lock control unit 19 does not transmit, to the lock control apparatus 50, the release instruction for releasing the lock of the locked shelf. Then, the lock control apparatus 50 does not release the lock of the locked shelf.

Further, when the customer determination information is not registered in the customer list (No in S22), the registration unit 12 registers the customer determination information in the customer list (see FIG. 4) stored in the storage unit 11 (S25). Subsequently, the processing in and after S26 is executed. The processing in and after S26 is as described above.

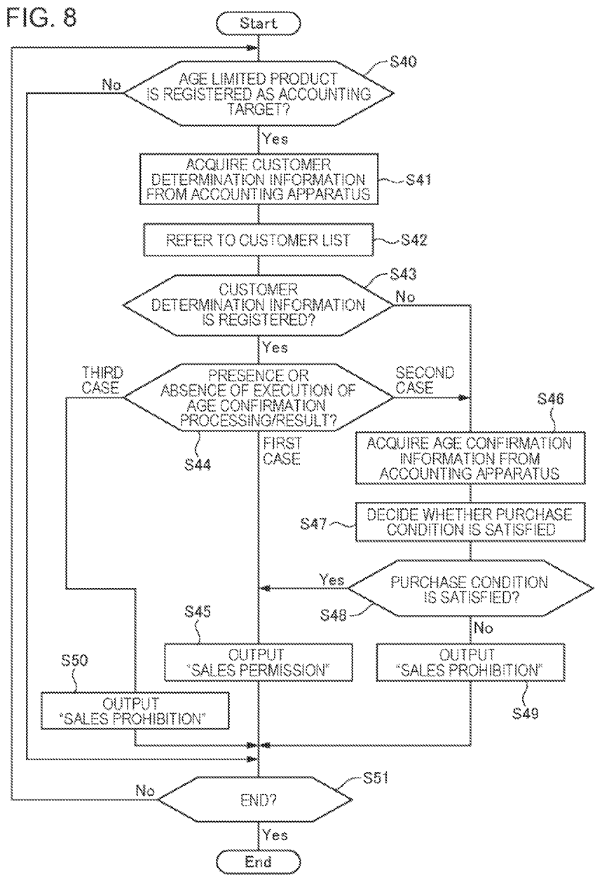

Next, one example of a flow of processing executed by the shop server 10 when a customer executes accounting processing will be described by using a flowchart in FIG. 8.

When a customer finishes picking up a purchase target, the customer operates the accounting apparatus 30, and executes the accounting processing. First, the customer executes registration processing of registering identification information about a product being an accounting target via an input apparatus such as a code reader that reads a code indicating identification information about a product, a touch panel display, a physical button, and a microphone, an input system including a camera that captures an appearance of a product and an image analysis apparatus, and the like, for example. When the accounting apparatus 30 receives an input of the identification information about the product, the accounting apparatus 30 acquires, from a product master stored in advance in the shop server 10 or the like, product information (such as a unit price) associated with the input identification information about the product, and registers the product information as an accounting target in a storage apparatus of the accounting apparatus 30.

Further, the accounting apparatus 30 surveys whether an age limited product is registered as an accounting target, based on “information indicating whether each product is an age limited product” stored in advance in the accounting apparatus 30. Then, when an age limited product is registered as an accounting target, the accounting apparatus 30 notifies the shop server 10 of the registration. The shop server 10 detects that the age limited product is registered as the accounting target, based on the notification (S40).

Then, when the age limited product is registered as the accounting target (Yes in S40), the shop server 10 acquires, from the accounting apparatus 30, customer determination information input to the accounting apparatus 30 (S41). The accounting apparatus 30 may output a guide that prompts all customers to input customer determination information, and receive an input of the customer determination information from all the customers. In addition, the accounting apparatus 30 may output a guide that prompts only a customer who registers an age limited product as an accounting target to input customer determination information, and receive an input of the customer determination information from only the customer who registers the age limited product as the accounting target.

When the accounting time decision unit 15 acquires the customer determination information from the accounting apparatus 30 (Yes in S41), the accounting time decision unit 15 refers to a customer list stored in the storage unit 11 (S42), and confirms whether the acquired customer determination information is registered in the customer list (S43). When the customer determination information is registered (Yes in S43), the accounting time decision unit 15 confirms whether the age confirmation processing having already been executed and a fact that a purchase condition of the age limited product is satisfied are registered in association with the customer determination information (S44).

When the age confirmation processing having already been executed and the fact that the purchase condition of the age limited product is satisfied are registered (first case in S44), the accounting control unit 16 transmits a sales permission to the accounting apparatus 30 (S45). In this case, the accounting apparatus 30 keeps continuing the accounting processing.

On the other hand, when the age confirmation processing having already been executed is not registered (second case in S44), the accounting control unit 16 transmits, to the accounting apparatus 30, a decision instruction for executing processing for deciding whether the customer satisfies the purchase condition. The accounting apparatus 30 receives, from the customer, the age confirmation processing in response to the decision instruction, and transmits input age confirmation information to the shop server 10.

When the accounting control unit 16 acquires the age confirmation information from the accounting apparatus 30 (S46), the accounting control unit 16 decides whether the customer satisfies the purchase condition, based on the age confirmation information (S47). Next, when the customer satisfies the purchase condition (Yes in S48), the accounting control unit 16 transmits the sales permission to the accounting apparatus 30 (S45). In this case, the accounting apparatus 30 keeps continuing the accounting processing.

On the other hand, when the customer does not satisfy the purchase condition (No in S48), the accounting control unit 16 transmits a sales prohibition to the accounting apparatus 30 (S49). In this case, the shop server 10 may cause the accounting apparatus 30 to execute error processing. The accounting apparatus 30 may output, as the error processing, a sentence such as, for example, “OO (name of an age limited product) cannot be sold because it cannot be confirmed that your age satisfies a purchase condition.” via an output apparatus such as a display and a speaker. Further, the accounting apparatus 30 may delete, from the accounting target, the age limited product registered as the accounting target.

Further, when the age confirmation processing having already been executed and the purchase condition of the age limited product not being satisfied are registered (third case in S44), the accounting control unit 16 transmits the sales prohibition to the accounting apparatus 30 (S50). In this case, the shop server 10 may cause the accounting apparatus 30 to execute the error processing. The accounting apparatus 30 may output, as the error processing, a sentence such as, for example, “OO (name of an age limited product) cannot be sold because it cannot be confirmed that your age satisfies a purchase condition.” via an output apparatus such as a display and a speaker. Further, the accounting apparatus 30 may delete, from the accounting target, the age limited product registered as the accounting target.

Further, when the customer determination information is not registered in the customer list (No in S43), the processing in and after S46 is executed. The processing in and after S46 is as described above.

Herein, a modification example of the present example embodiment will be described. For example, an operation terminal (an apparatus different from the accounting apparatus 30, the doorway apparatus 40, and the lock control apparatus 50) that receives an input of customer determination information and age confirmation information may be installed in any position in a shop. Then, a customer may input customer determination information and age confirmation information to the operation terminal at any timing after entering the shop and before the accounting processing, and may execute the age confirmation processing. The shop server 10 acquires the customer determination information and the age confirmation information from the operation terminal, executes processing similar to that when the shop server 10 acquires the pieces of information from the doorway apparatus 40 and the lock control apparatus 50, and updates a customer list.

Further, the taken-out time acquisition unit 17, the taken-out time decision unit 18, and the lock control unit 19 may be included in the lock control apparatus 50 instead of the shop server 10. In this case, the lock control apparatus 50 acquires a customer list from the shop server 10, and stores the customer list in a storage apparatus of the lock control apparatus 50.

Further, the accounting time acquisition unit 14, the accounting time decision unit 15, and the accounting control unit 16 may be included in the accounting apparatus 30 instead of the shop server 10. In this case, the accounting apparatus 30 acquires a customer list from the shop server 10, and stores the customer list in a storage apparatus of the accounting apparatus 30.

Further, in the example described above, membership identification information is used as customer determination information, but instead of or in addition to this, biometric information such as a fingerprint, a voiceprint, and an iris may be used. For example, a customer may register his/her biometric information at a time of advance membership registration. In this way, the biometric information is registered as membership information in the center server 20. In this case, the customer can input the biometric information as customer determination information to the accounting apparatus 30, the doorway apparatus 40, the lock control apparatus 50, and the like.

Further, in the example described above, a face image is used as customer determination information, but instead of or in addition to this, other biometric information such as a fingerprint, a voiceprint, and an iris may be used. In this case, a customer can input the other biometric information, such as a fingerprint, a voiceprint, and an iris, as customer determination information to the accounting apparatus 30, the doorway apparatus 40, the lock control apparatus 50, and the like.

Further, the lock control apparatus 50 may require reception of an input of a face image or other biometric information as customer determination information. In other words, the lock control apparatus 50 may not receive an input of membership identification information as customer determination information. In this way, an inconvenience that a lock of a locked shelf is released due to spoofing using membership identification information about another person can be suppressed.

Further, in the example described by using the flowchart in FIG. 7, when the age confirmation processing having already been executed and a purchase condition of an age limited product not being satisfied are registered (third case in S23), the error processing is abruptly executed (S31), but instead of this, also in a case of the “third case in S23”, the same processing (S26 to S30) as that in the “second case in S23” may be executed.

Further, in the example described by using the flowchart in FIG. 8, when the age confirmation processing having already been executed and a purchase condition of an age limited product not being satisfied are registered (third case in S44), a sales prohibition is abruptly output (S50), but instead of this, also in a case of the “third case in S443”, the same processing (S46 to S49) as that in the “second case in S44” may be executed.

Next, one example of a hardware configuration of the apparatus (the shop server 10, the center server 20, the accounting apparatus 30, the doorway apparatus 40, and the lock control apparatus 50) according to the present example embodiment will be described. A functional unit included in the apparatus according to the present example embodiment is achieved by any combination of hardware and software concentrating on a central processing unit (CPU) of any computer, a memory, a program loaded into the memory, a storage unit (that can also store a program downloaded from a storage medium such as a compact disc (CD), a server on the Internet, and the like in addition to a program stored in advance at a stage of shipping of an apparatus) such as a hard disk that stores the program, and a network connection interface. Then, various modification examples of a method for the achievement and an apparatus for the achievement are understood by a person skilled in the art.

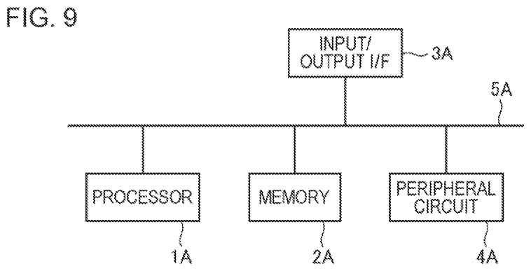

FIG. 9 is a block diagram illustrating the hardware configuration of the apparatus according to the present example embodiment. As illustrated in FIG. 9, the apparatus according to the present example embodiment includes a processor 1A, a memory 2A, an input/output interface 3A, a peripheral circuit 4A, and a bus 5A. Various modules are included in the peripheral circuit 4A. Note that, the peripheral circuit 4A may not be provided. Note that, each apparatus according to the present example embodiment may be formed of one apparatus integrated physically and/or logically, or may be formed of a plurality of apparatuses separated physically and/or logically. When each apparatus is formed of a plurality of apparatuses separated physically and/or logically, each of the plurality of apparatuses can include the hardware configuration described above.

The bus 5A is a data transmission path for the processor 1A, the memory 2A, the peripheral circuit 4A, and the input/output interface 3A to transmit and receive data to and from one another. The processor 1A is an arithmetic processing apparatus such as a CPU and a graphics processing unit (GPU), for example. The memory 2A is a memory such as a random access memory (RAM) and a read only memory (ROM), for example. The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a touch panel, a physical button, and the like. The output apparatus is, for example, a display, a speaker, a printer, a mailer, and the like. The processor 1A can output an instruction to each of modules, and perform an arithmetic operation, based on an arithmetic result of the modules.

Note that, in the present specification, “acquisition” may include “acquisition of data stored in another apparatus or a storage medium by its own apparatus (active acquisition)”, based on a user input or an instruction of a program, such as reception by making a request or an inquiry to another apparatus, and reading by accessing to another apparatus or a storage medium, for example. Further, “acquisition” may include “inputting of data output from another apparatus to its own apparatus (passive acquisition)”, based on a user input or an instruction of a program, such as reception of data to be distributed (or transmitted, push-notified, or the like), for example. Further, “acquisition” may include acquisition by selection from among pieces of received data or pieces of received information, and “generation of new data by editing data (such as texting, sorting of data, extraction of a part of data, and change of a file format) and the like, and acquisition of the new data”.

Next, an advantageous effect of the present example embodiment will be described.

The shop server 10 according to the present example embodiment confirms whether a customer satisfies a purchase condition of an age limited product at both of a time at which the age limited product is taken out from a locked shelf and an accounting time. Thus, even at an occurrence of wrongdoing in such a way that a customer who does not satisfy a purchase condition takes out an age limited product from a locked shelf when another customer releases a lock of the locked shelf, the customer cannot normally execute the accounting processing. Thus, an inconvenience of selling an age limited product to a customer who does not satisfy a purchase condition can be suppressed.

Further, in a case of the shop server 10 according to the present example embodiment, when the age confirmation processing is executed at any of a time of advance membership registration, a time at which a customer enters a shop, and a time at which an age limited product is taken out from a locked shelf, the age confirmation processing being executed and a decision result are registered in the shop server 10. Then, after the registration, the shop server 10 confirms whether a customer satisfies a purchase condition of the age limited product, based on the registration information. Thus, as described above, the shop server 10 confirms whether a customer satisfies a purchase condition of an age limited product twice at a time at which the age limited product is taken out from a locked shelf and an accounting time, but the customer should execute the age confirmation processing only once, and the processing being executed for a plurality of times can be avoided. Thus, convenience improves.

Further, in the present example embodiment, a customer is required to input customer determination information to the doorway apparatus 40 when the customer enters a shop. However, it is expected that a customer who enters a shop without following this appears. Further, even with a configuration in which a door or a gate in a doorway opens in response to an input of customer determination information to the doorway apparatus 40, it is expected that a customer who enters a shop when another customer opens the door or the gate in the doorway appears. Thus, a situation where customer determination information input to the lock control apparatus 50 is not registered in a customer list may occur.

However, the shop server 10 according to the present example embodiment can set not only “the age confirmation processing having already been executed is not registered, in the customer list, in association with customer determination information input to the lock control apparatus 50”, but also “customer determination information input to the lock control apparatus 50 is not registered in the customer list” as a condition for transmitting, to the lock control apparatus 50, a decision instruction for executing processing for deciding whether a customer satisfies a purchase condition. Thus, even when a customer who enters a shop without following a request as described above appears, sale of an age limited product can be normally performed.

Furthermore, in the present example embodiment, when an age limited product is taken out from a locked shelf, an input of customer determination information to the lock control apparatus 50 is needed. However, it is expected that a customer who takes out an age limited product from a locked shelf when another customer releases a lock of the locked shelf appears. Thus, a situation where a customer does not input his/her customer determination information at both of a time at which the customer enters a shop and a time at which the customer takes out an age limited product, and the customer determination information input to the accounting apparatus 30 at an accounting time is not registered in a customer list may occur.

However, the shop server 10 according to the present example embodiment can set not only “the age confirmation processing having already been executed is not registered, in the customer list, in association with customer determination information input to the accounting apparatus 30”, but also “customer determination information input to the accounting apparatus 30 is not registered in the customer list” as a condition for transmitting, to the accounting apparatus 30, a decision instruction for executing processing for deciding whether a customer satisfies a purchase condition. Thus, even when a customer who enters a shop without following a request as described above or a customer who takes out an age limited product from a locked shelf when another customer releases a lock of the locked shelf appears, sale of an age limited product can be normally performed.

Further, in a case of the shop server 10 according to the present example embodiment, a customer can execute the age confirmation processing in a shop when the customer comes to the shop. In this case, advance processing before the customer comes to the shop is unnecessary, and thus convenience of the customer improves.

Further, in a case of the shop server 10 according to the present example embodiment, certain limitation is imposed not only at an accounting time but also when a customer picks up an age limited product from a shelf Thus, as long as a customer who does not satisfy a purchase condition performs an action in such a way as to take out an age limited product from a locked shelf when another customer releases a lock of the locked shelf, the customer cannot take out the age limited product from the shelf. When limitation is imposed only at an accounting time, a customer is notified that an age limited product cannot be purchased at the accounting time. In this case, an inconvenience that the age limited product is left alone near the accounting apparatus 30 and the like may occur. The inconvenience can be reduced by also imposing limitation when an age limited product is picked up from a shelf.

Further, in a case of the present example embodiment, the shop server 10 can hold information (customer list) indicating whether each customer satisfies a purchase condition. When a configuration in which a server outside a shop, such as the center server 20, holds the information and the shop server 10 makes an inquiry to the server outside the shop is adopted, an inconvenience that it takes communication time, waiting time for a customer occurs, and the like may occur. In a case of the present example embodiment in which the shop server 10 holds information (customer list) indicating whether each customer satisfies a purchase condition, the inconvenience can be reduced.

A part or the whole of the above-described example embodiments may also be described as in supplementary notes below, which is not limited thereto.

1. A shop system, including:

a taken-out time acquisition means for acquiring customer determination information input to a lock control apparatus that controls a lock of a locked shelf in which an age limited product is displayed;

a taken-out time decision means for deciding whether a customer determined by the customer determination information has already executed age confirmation processing and whether the customer satisfies a purchase condition of the age limited product; and

a lock control means for transmitting, to the lock control apparatus, a release instruction for releasing a lock of the locked shelf when the customer has already executed the age confirmation processing and satisfies the purchase condition.

2. The shop system according to supplementary note 1, further including;

the lock control apparatus receiving an input of age confirmation information when the customer has not yet executed the age confirmation processing; and

a purchase condition decision means for deciding whether the customer satisfies the purchase condition, based on the age confirmation information, wherein

the lock control means transmits the release instruction to the lock control apparatus when a decision result by the purchase condition decision means indicates that the purchase condition is satisfied.

3. The shop system according to supplementary note 1 or 2, wherein

the lock control apparatus receives an input of biometric information as the customer determination information.

4. The shop system according to any of supplementary notes 1 to 3, wherein

the taken-out time decision means decides whether the customer has already executed the age confirmation processing and whether the customer satisfies the purchase condition, based on a customer list in which the customer determination information, information indicating whether the age confirmation processing has already been executed, and information indicating whether the purchase condition is satisfied are associated with one another.

5. A shop system, including:

an accounting time acquisition means for acquiring customer determination information input to an accounting apparatus;

an accounting time decision means for deciding, when an age limited product is registered as an accounting target in the accounting apparatus, whether a customer determined by the customer determination information has already executed age confirmation processing and whether the customer satisfies a purchase condition of the age limited product; and

an accounting control means for transmitting a sales permission to the accounting apparatus when the customer has already executed the age confirmation processing and satisfies the purchase condition.

6. The shop system according to supplementary note 5, wherein

the accounting apparatus receives an input of age confirmation information when the customer has not yet executed the age confirmation processing, and

the accounting control means decides whether the customer satisfies the purchase condition, based on the age confirmation information, and transmits the sales permission to the accounting apparatus when deciding that the purchase condition is satisfied.

7. The shop system according to supplementary note 5 or 6, wherein

the accounting time decision means decides whether the customer has already executed the age confirmation processing and whether the customer satisfies the purchase condition, based on a customer list in which the customer determination information, information indicating whether the age confirmation processing has already been executed, and information indicating whether the purchase condition is satisfied are associated with one another.

8. The shop system according to supplementary note 4 or 7, wherein

the purchase condition decision means decides whether the customer satisfies the purchase condition, based on age confirmation information input to a doorway apparatus or the lock control apparatus, and registers a decision result in the customer list.

9. The shop system according to supplementary note 4, 7, or 8, wherein

the purchase condition decision means acquires, from a center server, a decision result of whether the customer determined by the customer determination information input to a doorway apparatus or the lock control apparatus satisfies the purchase condition, and registers the decision result in the customer list.

10. A processing method of a shop system, including:

by a shop system,
acquiring customer determination information input to a lock control apparatus that controls a lock of a locked shelf in which an age limited product is displayed;
deciding whether a customer determined by the customer determination information has already executed age confirmation processing and whether the customer satisfies a purchase condition of the age limited product; and
transmitting, to the lock control apparatus, a release instruction for releasing a lock of the locked shelf when the customer has already executed the age confirmation processing and satisfies the purchase condition.
   11. A processing method of a shop system, including:

by a shop system,
acquiring customer determination information input to an accounting apparatus;
deciding, when an age limited product is registered as an accounting target in the accounting apparatus, whether a customer determined by the customer determination information has already executed age confirmation processing and whether the customer satisfies a purchase condition of the age limited product; and
transmitting a sales permission to the accounting apparatus when the customer has already executed the age confirmation processing and satisfies the purchase condition.
   12. A shop server, including:

a registration means for registering, in a customer list, customer determination information acquired from a customer;

a purchase condition decision means for deciding whether the customer satisfies a purchase condition of an age limited product, based on age confirmation information acquired from the customer when the customer enters a shop or the customer takes out the age limited product from a locked shelf, and registering, in the customer list, a decision result in association with the customer determination information;

an accounting time acquisition means for acquiring the customer determination information input to an accounting apparatus;

an accounting time decision means for referring to the customer list when the age limited product is registered as an accounting target in the accounting apparatus, and deciding whether a fact that purchase condition is satisfied is registered in association with the customer determination information input to the accounting apparatus; and

an accounting control means for transmitting, to the accounting apparatus, a decision instruction for executing processing for deciding whether the customer satisfies the purchase condition, when a fact that the purchase condition is satisfied is not registered in association with the customer determination information input to the accounting apparatus.

13. A processing method of a shop server, including:

by the shop server,
registering, in a customer list, customer determination information acquired from a customer;
deciding whether the customer satisfies a purchase condition of an age limited product, based on age confirmation information acquired from the customer when the customer enters a shop or the customer takes out the age limited product from a locked shelf, and registering, in the customer list, a decision result in association with the customer determination information;
acquiring the customer determination information input to an accounting apparatus;
referring to the customer list when the age limited product is registered as an accounting target in the accounting apparatus, and deciding whether a fact that the purchase condition is satisfied is registered in association with the customer determination information input to the accounting apparatus; and
transmitting, to the accounting apparatus, a decision instruction for executing processing for deciding whether the customer satisfies the purchase condition, when a fact that the purchase condition is satisfied is not registered in association with the customer determination information input to the accounting apparatus.
   14. A program causing a shop server to function as:

a registration means for registering, in a customer list, customer determination information acquired from a customer;

a purchase condition decision means for deciding whether the customer satisfies a purchase condition of an age limited product, based on age confirmation information acquired from the customer when the customer enters a shop or the customer takes out the age limited product from a locked shelf, and registering, in the customer list, a decision result in association with the customer determination information;

an accounting time acquisition means for acquiring the customer determination information input to an accounting apparatus;

an accounting time decision means for referring to the customer list when the age limited product is registered as an accounting target in the accounting apparatus, and deciding whether a fact that the purchase condition is satisfied is registered in association with the customer determination information input to the accounting apparatus; and

an accounting control means for transmitting, to the accounting apparatus, a decision instruction for executing processing for deciding whether the customer satisfies the purchase condition, when a fact that the purchase condition is satisfied is not registered in association with the customer determination information input to the accounting apparatus.

The invention of the present application is described above with reference to the example embodiments (examples), but the invention of the present application is not limited to the example embodiments (examples) described above. Various modifications that can be understood by those skilled in the art can be made to the configuration and the details of the invention of the present application within the scope of the invention of the present application.

This application is based upon and claims the benefit of priority from Japanese patent application No. 2019-178290, filed on Sep. 30, 2019, the disclosure of which is incorporated herein in its entirety by reference.

### REFERENCE SIGNS LIST

1A Processor
2A Memory
3A Input/output I/F
4A Peripheral circuit
5A Bus
10 Shop server
11 Storage unit
12 Registration unit
13 Purchase condition decision unit
14 Accounting time acquisition unit
15 Accounting time decision unit
16 Accounting control unit
17 Taken-out time acquisition unit
18 Taken-out time decision unit
29 Lock control unit
20 Center server
30 Accounting apparatus
40 Doorway apparatus
50 Lock control apparatus

What is claimed is:

1. A shop system, comprising:
at least one memory configured to store one or more instructions; and
at least one processor configured to execute the one or more instructions to:
acquire customer determination information input to a lock control apparatus that controls a lock of a locked shelf in which an age limited product is displayed;
decide whether a customer determined by the customer determination information has already executed age confirmation processing and whether the customer satisfies a purchase condition of the age limited product; and
transmit, to the lock control apparatus, a release instruction for releasing a lock of the locked shelf when the customer has already executed the age confirmation processing and satisfies the purchase condition.

2. The shop system according to claim 1,
wherein the lock control apparatus receives an input of age confirmation information when the customer has not yet executed the age confirmation processing; and
wherein the processor is further configured to execute the one or more instructions to:
decide whether the customer satisfies the purchase condition, based on the age confirmation information, and
transmit the release instruction to the lock control apparatus when a decision result based on the age confirmation information indicates that the purchase condition is satisfied.

3. The shop system according to claim 1, wherein
the lock control apparatus receives an input of biometric information as the customer determination information.

4. The shop system according to claim 1, wherein the processor is further configured to execute the one or more instructions to decide whether the customer has already executed the age confirmation processing and whether the customer satisfies the purchase condition, based on a customer list in which the customer determination information, information indicating whether the age confirmation processing has already been executed, and information indicating whether the purchase condition is satisfied are associated with one another.

5. A shop system, comprising:
at least one memory configured to store one or more instructions; and
at least one processor configured to execute the one or more instructions to:
acquire customer determination information input to an accounting apparatus;
decide, when an age limited product is registered as an accounting target in the accounting apparatus, whether a customer determined by the customer determination information has already executed age confirmation processing and whether the customer satisfies a purchase condition of the age limited product; and
transmit a sales permission to the accounting apparatus when the customer has already executed the age confirmation processing and satisfies the purchase condition.

6. The shop system according to claim 5, wherein
the accounting apparatus receives an input of age confirmation information when the customer has not yet executed the age confirmation processing, and
the processor is further configured to execute the one or more instructions to decide whether the customer satisfies the purchase condition, based on the age confirmation information, and transmit the sales permission to the accounting apparatus when deciding that the purchase condition is satisfied.

7. The shop system according to claim 5, wherein the processor is further configured to execute the one or more instructions to decide whether the customer has already executed the age confirmation processing and whether the customer satisfies the purchase condition, based on a customer list in which the customer determination information, information indicating whether the age confirmation processing has already been executed, and information indicating whether the purchase condition is satisfied are associated with one another.

8. The shop system according to claim 4, wherein the processor is further configured to execute the one or more instructions to decide whether the customer satisfies the purchase condition, based on age confirmation information input to a doorway apparatus or the lock control apparatus, and register a decision result in the customer list.

9. The shop system according to claim 4, wherein the processor is further configured to execute the one or more instructions to acquire, from a center server, a decision result of whether the customer determined by the customer determination information input to a doorway apparatus or the lock control apparatus satisfies the purchase condition, and register the decision result in the customer list.

10.-11. (canceled)

12. A shop server, comprising:
at least one memory configured to store one or more instructions; and
at least one processor configured to execute the one or more instructions to:
register, in a customer list, customer determination information acquired from a customer;
decide whether the customer satisfies a purchase condition of an age limited product, based on age confirmation information acquired from the customer when the customer enters a shop or the customer takes out the age limited product from a locked shelf, and register, in the customer list, a decision result in association with the customer determination information;
acquire the customer determination information input to an accounting apparatus;
refer to the customer list when the age limited product is registered as an accounting target in the accounting apparatus, and decide whether a fact that the purchase condition is satisfied is registered in association with the customer determination information input to the accounting apparatus; and
transmit, to the accounting apparatus, a decision instruction for executing processing for deciding whether the customer satisfies the purchase condition, when a fact that the purchase condition is satisfied is not registered in association with the customer determination information input to the accounting apparatus.
